(19) United States
(12) Patent Application Publication
(10) Pub. No.: US 2016/0302901 A1
(43) Pub. Date: Oct. 20, 2016

(54) SYSTEM FOR DETERMINING THE CONTACT SURFACE AND THE DISTRIBUTION OF OCCLUSAL FORCES BETWEEN THE TEETH OF A PATIENT'S JAW, AND CORRESPONDING METHOD

(71) Applicant: ODAXOS, Laval (FR)

(72) Inventors: Olivier Brel, Laval (FR); Geneviève Brel, Laval (FR); Yannick Kervran, Rennes (FR); Tayeb Mohammed-Brahim, Rennes (FR); Samuel Cran, Le Petit Fougeray (FR); Olivier Le Monies de Sagazan, Rennes (FR)

(73) Assignee: ODAXOS, Laval (FR)

(21) Appl. No.: 15/101,245

(22) PCT Filed: Dec. 3, 2014
(86) PCT No.: PCT/FR2014/053155

§ 371 Date: Jun. 2, 2016

(30) Foreign Application Priority Data
Dec. 3, 2013 (FR) 1361996

(51) Int. Cl. A61C 19/05; G01L 1/20

(52) U.S. Cl. CPC A61C 19/05; G01L 1/205

(57) ABSTRACT

The invention relates to a system and method for determining the occlusal surface of a patient's jaw. The system comprises a contact-detecting member designed to be inserted between the patient's teeth and means for calculating the distribution of occlusal forces in order to produce a map. The detector member comprises a removable flexible plate formed by a sheet of flexible plastic material solidly connected to a grid of pressure sensors comprising a first layer including three layers, two electrode layers sandwiching an intermediate layer having a resistivity that varies according to the pressure applied thereto. The electrodes define so-called intersection zones forming at least 5000 sensors having a square cross-section of less than or equal to 600 micrometres. The intermediate layer comprises a microcrystalline silicon semiconductor wafer having a thickness less than or equal to 50 nanometres.

The present invention relates to a system for determining the contact surface and the distribution of the occlusal forces exerted between the upper teeth and the lower teeth of a jaw of a patient, comprising a member for detecting contacts between the teeth arranged to be inserted between the teeth of the patient, elements for connecting the detecting member with means for computing the distribution of the occlusal forces to produce therefrom the mapping and said computation means.

It relates also to a method implementing such a system and a removable flexible plate used with such a system.

The invention is particularly applicable, although not exclusively applicable, in the field of the taking of dental imprints and/or the surface treatment (polishing) of the surfaces of the teeth entering into contact with one another notably to ensure a good dental occlusion.

Good occlusion should be understood here to mean a good distribution of the pressure forces between maxillary teeth and mandibular teeth when chewing and/or when the patient tightens the jaws.

In dental care, for example when fitting an implant, the practitioner has to check the good dental occlusion of the patient. More specifically, the dentist has to check that the newly installed implant does not hamper the movement of the jaw and/or does not create any remaining internal pressure at rest.

It is known that occlusion defects even of the order of a few micrometers, and which occur in static mode and/or in dynamic mode, can be generators of discomforts and/or illnesses for the patient, such as, in particular, necroses or loosenings of the teeth, or can even bring about postural problems in the patient or headaches, possibly leading to depressions.

To avoid such drawbacks, the dentist fitting a prosthesis for example seeks to adjust it by trying to detect the hard points in order to file away the parts of the implant or of the teeth which hamper a good occlusion.

Devices for detecting good occlusal contacts are known. They use substrates impregnated with colored agents released by chewing, commonly referred to as articulating paper, like those marketed by the German company Bausch.

Such devices do however present drawbacks.

They do not allow for measurements that are accurate, safe and can easily be repeated. They in effect involve a read that is visual and therefore necessarily subjective on the part of the dentist concerning the coloration density, rather than making it possible to obtain an objective result.

Moreover, none of these devices determines the occlusion dynamically or makes it possible to take a dental imprint which can be conserved in digital form then modified subsequently in time.

Determining the occlusion dynamically should be understood to mean measuring the order of appearance of the occlusion points during a movement of the jaw when actually taking an imprint.

The possibility of modifying the file will, for its part, make it possible to refresh and/or update the data relative to the model of dentition of the patient.

Also known are sensor devices for contact between two opposing objects (EP 0 216 899) comprising a set of electrodes mounted on a support sheet.

However, these do not exhibit sufficient mechanical flexibility. For that reason they modify the behavior of the jaw to be measured, which makes them less reliable. Furthermore, they do not have significant spatial resolution.

The present invention aims to mitigate these drawbacks and proposes a device and a method that provide a better response to the demands of the practice than those previously known, notably in that it will allow for measurements that are reliable, repetitive, in the form of digital files that can easily be manipulated, allowing for comparisons and diagnoses hitherto impossible to achieve.

The dental practitioner will be able to accurately perform the dentition corrections for his patients, which will result in considerably improved comfort and health for the latter.

With the invention, it will therefore be possible to measure the pressure field applied to a non-planar surface with a spatial resolution of a hundred or so micrometers using a network of restrictions.

To this end, the invention specifically proposes a system for determining the contact surface and the distribution of the forces exerted between the upper teeth and the lower teeth of a jaw of a patient comprising a member for detecting contacts between the teeth arranged to be inserted between the teeth of the patient, elements for connecting the detecting member with means for computing the distribution of the occlusal forces to produce therefrom the mapping and said computation means,

characterized in that said detecting member comprises a support piece for a removable flexible plate, said flexible plate being formed from a sheet of flexible plastic material secured to a grid of pressure sensors comprising a first layer having a first array of electrodes called row electrodes, generally parallel, an intermediate second layer of variable resistivity as a function of the pressure which is applied thereto, and a third layer comprising a second array of electrodes, called column electrodes, generally parallel, defining so-called zones of intersection with the row electrodes, in that the grid of sensors comprises at least 5000 zones of intersection adjacent to one another, of square section less than or equal to 600 micrometers,
and in that the intermediate layer comprises a wafer of semiconductive monocrystalline silicon of a thickness less than or equal to 50 nanometers.

By using a very large number of measurement points, i.e. more than 5000, each consisting of a sensor, the set of the sensors forming a mesh, it is possible to produce an accurate and spatially fine measurement (a measurement point of the order of 500 μm in both directions of space).

It will be noted that the layers and/or wafers which are usually of mutually different thicknesses are, by contrast, of constant or substantially constant thicknesses.

Similarly, by using a material for the intermediate layer that is of small thickness and which, subjected to pressures that can range beyond 600 N, is deformed sufficiently to not hamper the measurement, a sufficient flexibility of the sensor is thus assured.

In advantageous embodiments, there is also and/or in addition recourse to one and/or the other of the following arrangements:
the intermediate layer is formed by plasma deposition of doped silicon on an insulating layer;
the electrodes are of aluminum;
the first layer comprises more than one hundred row electrodes and the third layer comprises more than fifty column electrodes;
the first layer is of a thickness of between 200 nm and 400 nm, the planar wafer of monocrystalline silicon is of a thickness less than 30 nm and the third layer is of a thickness of between 400 nm and 600 nm;
the connection elements comprise an acquisition board and a connection pin with the support piece;
the computation means comprise means arranged to display dynamically on a computer screen the mapping of the occlusal forces by incorporating data of the jaw specific to a determined patient.

The invention also proposes a method for determining the contact surface and the distribution of the occlusal forces of a jaw of a patient, making it possible to obtain the mapping of said occlusal forces implementing a system as described above.

It also proposes a method for determining the contact surface and the distribution of the occlusal forces exerted between the upper teeth and the lower teeth of a jaw of a patient, suitable for taking a dental imprint, in which the contacts between the teeth are detected by the insertion of a member between the teeth of the patient, the pressures are measured via said member provided with a sheet of flexible plastic material glued onto a grid of pressure sensors comprising at least 5000 sensors adjacent to one another, of square section less than or equal to 600 micrometers, said grid comprising an intermediate layer of variable resistivity as a function of the pressure, said intermediate layer comprising a wafer of semiconductor monocrystalline silicon of a thickness less than or equal to 50 nanometers, and the mapping of the occlusal forces is computed from the distribution of the pressures measured.

Advantageously the mapping is displayed dynamically on a computer screen by incorporating complementary data.

The invention relates also to a removable flexible plate used with such a system and as described hereinabove.

Advantageously, the plate is disposable.

The invention will be better understood on reading the following description of an embodiment given below by way of nonlimiting example.

The description refers to the accompanying drawings in which:

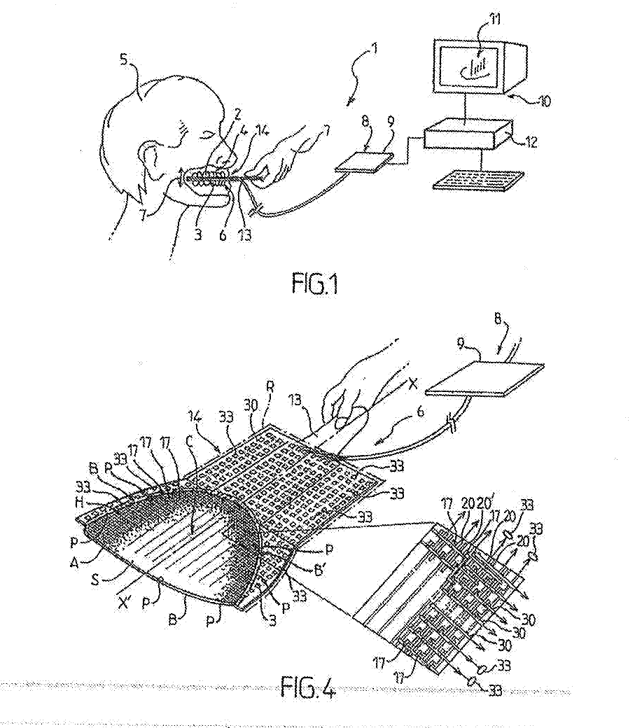

FIG. 1 is a schematic view showing the system according to the invention in operation with a patient.

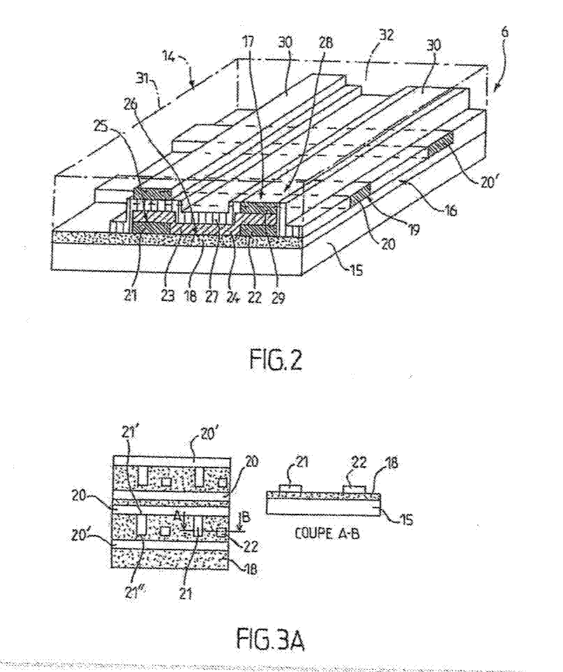

FIG. 2 is an enlarged, exploded and partial perspective view of the flexible plate of the detecting member of the system of FIG. 1 (the proportions between the layers are not to scale).

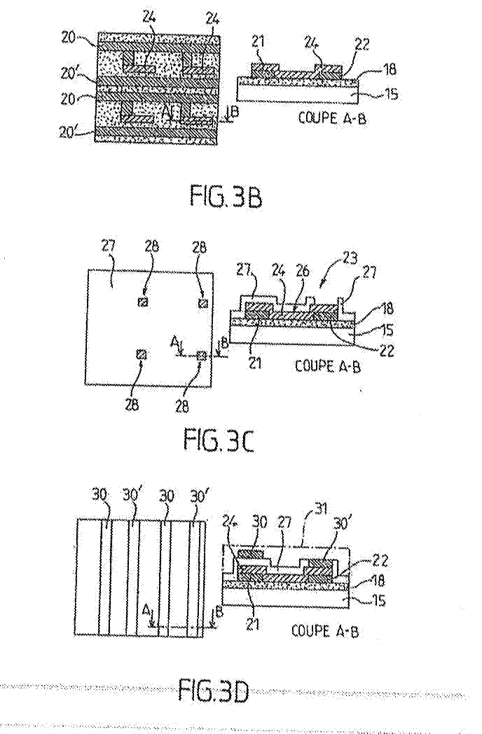

FIGS. 3A to 3D illustrate the steps in producing a pressure sensor of the detection member of FIG. 2, in plan view and in transverse cross section A-B.

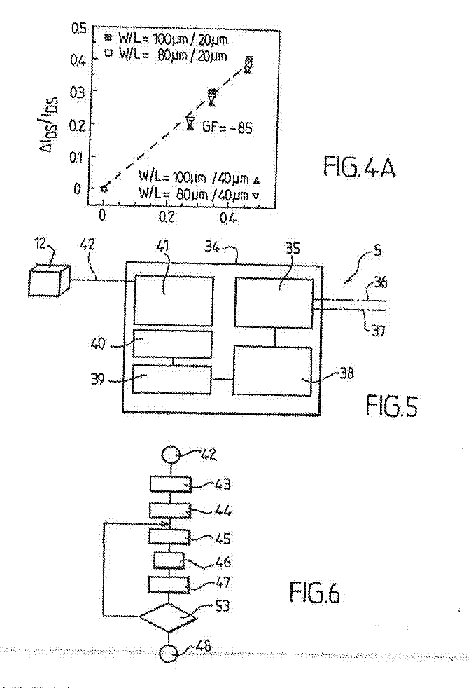

FIG. 4 is a perspective schematic view showing more specifically an embodiment of the detecting member of FIG. 1.

FIG. 4A shows an experimental curve of measurement of the variation of the electrical intensity as a function of the deformation of the sensor for four sensor dimensions.

FIG. 5 is a schematic view of the acquisition board belonging to the connection elements of the system of FIG. 1.

FIG. 6 is a flow diagram showing the main steps of an embodiment of the method according to the invention.

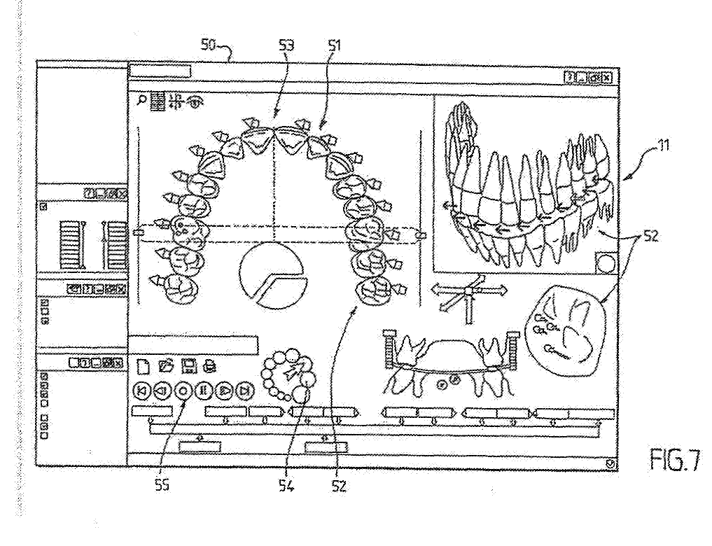

FIG. 7 is an example of a view of a computer screen illustrating a presentation of measurements and of the occlusal mapping of a patient obtained using the invention.

FIG. 1 shows a system 1 for determining the contact surface and the distribution of the occlusal forces between the upper teeth 2 and the lower teeth 3 of a jaw 4 of a patient 5.

The system 1 comprises a member 6 for detecting contacts between the teeth.

This member 6 is inserted by the dentist (hand 7) between the teeth of the patient in a removable manner, to detect the field of pressures (arrow 7) when the jaw is tightened.

The detecting member 6 is connected, by connection means 8, comprising an electronic board 9 which will be detailed with reference to FIG. 5, with computation means 10 arranged to produce the mapping, presented dynamically by an image 11 on the screen of the computer 12.

The detecting member 6 comprises a support piece 13 for a removable flexible plate 14, the construction of which will now be described with reference to FIG. 2.

The plate or piece 14 is planar, for example of parallelepipedal form, measuring 7 cm×7 cm to be easily introduced into the mouth of the patient and, for example, with an overall thickness of the order of 800 μm.

It comprises a support sheet 15 of plastic material, for example flexible polyethylene naphthalate (PEN), glued onto a grid 16 of pressure sensors 17.

Flexible should be understood to mean a plate capable of accepting bending radii less than 1.5 mm.

The support sheet 15 is substantially parallelepipedal, of a size of the order of, or less than, that of the plate.

The piece 14 comprises a thin layer 18, of ceramic, for example of a thickness of 100 micrometers glued onto the sheet or PEN 15, for example of silicon nitride and of dimensions equal to those of the sheet 15.

The duly formed assembly comprises, on the top, a first layer 19 comprising a first array of electrodes 20, 20′, called row electrodes.

Each electrode is a metal wire, for example of flattened rectangular section, elongate, electrically conductive, for example of aluminum.

The width of the electrodes is less than 2 mm, for example 0.5 mm, and the thickness is, for example, between 150 nm and 500 nm, for example between 200 and 400, for example 300 nm.

The array of electrodes is thus formed by an array of row electrodes substantially mutually parallel, and spaced apart by a width less than 2 mm, for example 0.25 mm.

In the embodiment more particularly described here, the number of the row electrodes is greater than 100, for example 120, and they operate in pairs 20, 20′.

Conductive elements 21 and 22 are also provided and will be detailed hereinbelow.

An intermediate layer 23 is placed on the first layer 19 of row electrodes.

This intermediate layer 23 comprises a semiconductive layer or wafer 24 of piezoelectric material. The piezoelectric material is semiconductive microcrystalline silicon (doped for example with arsenic).

The wafer 24 covers, with a substantially uniform thickness of between 30 nm and 100 nm, the parts 25 associated with the array of row electrodes and the space 26 between them, by forming an electrical bridge between said parts which will be detailed hereinbelow.

The space between two pairs of row electrodes 20, 20′, for its part, comprises no layer of semiconductive material.

The intermediate layer 21 also comprises a layer 27 of electrically insulating material over the semiconductive layer 24.

It has lateral and longitudinal dimensions equal to those of the plastic sheet and a maximum thickness of between 50 nm and 250 nm.

It entirely covers the first layer 19 of electrodes 20, 20′ and the semiconductive layer 24 except in determined places 28 which will be detailed with reference to FIGS. 3A to 3D.

The duly formed intermediate layer 27 is of variable resistivity as a function of the pressure and/or deformation which is applied to it.

The detecting member 6 and more specifically the piece 14 also comprises, above the intermediate layer 23, a third layer 29 comprising a second array of metal electrodes, called column electrodes 30.

The column electrodes 30 are for example similar to the row electrodes but are arranged in such a way that the superpositioning of said row and column arrays forms a grid.

For example, the two arrays are substantially orthogonal to one another defining so-called zones of intersection with the row electrodes to form the pressure sensors 17 glued to the plate.

Advantageously, a protective layer 31 (chain dotted line in FIG. 2), that is neutral (insulating), fills the voids and protects the top of the piece 14 for it to exhibit a planar face 32 arranged to cooperate with the measured object.

The column electrodes are of a thickness of between 400 nm and 600 nm and there are more than 40 thereof, for example 54.

Since the number of sensors 17 is equal to the number of intersections of the grid, in the embodiment particularly described here, the latter is greater than 4000, for example 6480. The grid therefore comprises at least 5000 sensors adjacent to one another and, since the intersection is orthogonal, the section of the sensors is square and less than or equal to 600 micrometers.

A method for fabricating the sensor member according to an embodiment of the invention will now be described with reference to FIGS. 3A to 3D.

This method comprises a first step (FIG. 3A) of provision of a first substrate of polyimide in the form of plastic film such as those marketed by the company DuPont Teijin Films to form the support sheet 15.

The latter forms a substantially parallelepipedal plate of rectangular section for example equal to or less than 15 cm by 15 cm and of a thickness less than 125 μm, for example less than 50 μm (for example 10 cm×10 cm×10 m).

Advantageously, the plate is freed of its impurities by cleaning in an ultrasound bath with acetone and rinsed with ethanol or isopropanol in a manner known per se.

A second step is then performed, of deposition of the layer of ceramic 18 such as silicon nitride. It involves, for example, a plasma-assisted chemical vapor phase deposition (PECVD). The gaseous phase of the PECVD consists of a gaseous mixture of silicon tetrahydride (SiH4), called saline, nitrogen (N2) and hydrogen (H2), and performed at a temperature less than 200°, for example 165° C.

The layer of silicon nitride which is sought is of a thickness less than 100 nm, for example of 50 nm.

A third step is then carried out, of deposition, on the ceramic layer 18, of the array or layer of row electrodes 20, 20′.

The deposition is performed by electron beam lithography or by Joule effect evaporation, to create the metallic row contacts over a thickness of the order of 300 nm.

The contacts are then etched by wet etching. For example, the sample is immersed in a hot bath of aluminum (approximately 50° C.) with an etching agent such as phosphoric acid (H3PO4) for a determined time. This determined time can be of the order of 2 to 3 minutes.

The sample is then rinsed under distilled water and dried under a gaseous flux of N2.

In the embodiment more particularly described here, the metal contacts comprise, a first row electrode 20, a second row electrode 20′ parallel to the first and a first 21 and second 22 bump contacts.

The first bump contact 21 is substantially parallelepipedal and orthogonal to the electrodes by being linked to the first electrode 20 and extends in the space between the pair 20, 20′ of electrodes.

Level with the end portion of the first bump contact 21, there is the second bump contact 22 of square form.

The intermediate layer 23 is formed in a fourth step (FIGS. 3B and 3C).

The fabrication method consists of a substep of deposition of the piezoelectric layer 24 of semiconductors.

The piezoelectric layer 24 entirely covers the bump contacts 21, 22 of the row electrodes and fills the space between the two electrode bump contacts 21 and 22 of a same pair.

The deposition is performed by PECVD, for example by depositing a thickness of approximately 130 nm of arsenic-doped microcrystalline silicon nitride (AsH4).

The process is once again followed by a photolithography. The etching is done by a method known to those skilled in the art as reactive ion etching (RIE) by using plasma sulfur hexafluoride (SF6).

The intermediate layer is thus formed by plasma deposition of the doped silicon under an insulating layer.

The second substep of the formation of this layer, for its part, consists in depositing the layer of electrically insulating material. This layer is of a maximum thickness of 300 nm.

This layer will comprise through-holes 28 in line with the second bump contacts 22 of the first row electrode array layer.

The insulating material is, for example, silicon oxide (SiO2). It is deposited for example by sputtering and is followed by a photolithography. The etching is done by reactive ion etching RIE by using SF6.

In a fifth step (FIG. 3D) there is the deposition of the layer, called third layer, of column electrodes 30, 30′, for example of 500 nm thickness, in aluminum by Joule effect evaporation, followed by a photolithography to create the second metal column contacts 22, in an array orthogonal to the row array.

The array is arranged in such a way that the rows of a pair of column electrodes 30 pass in line with the first 21 and second 22 bump contacts.

One of the column electrodes 30 of the pair directly tops, in order, an insulating layer 27, a piezoelectric layer 24 and the first bump contact 21.

The other is directly in line with a piezoelectric layer 24 and the second bump contact 22.

Here again, a wet-based etching technique is for example used as previously.

In one embodiment of the invention the assembly previously obtained undergoes a thermal bake at low temperature (for example less than 200° C., for example 180° C.) for a determined time, for example 2 hours, in an oven. This improves the microcrystalline silicon/aluminum interface, and increases the conductivity by a factor greater than 1.5, even 2.

FIG. 4 shows, in perspective, the sensor member 6 of FIG. 1. The latter comprises a support piece S in the form of a filiform arc A, rigid, externally supporting the plate 14 onto which it is fixed for example removably by self-adhesive spots P distributed on the outer face of the support sheet 15 of flexible plastic material, of the plate 14.

More specifically, the support piece S comprises on one side a U-shaped part designed to be placed on the side of the teeth and is closed on the other side by a bar B rigidifying the arms of the U-shape which will come over the part of the patient. The rigid arc form, slightly spoon-shaped for example, of the support piece is arranged to be inserted easily into the mouth of the patient so that the plate 14 can be in contact, sandwiched between the teeth above and below, freeing precisely this contact surface.

In other words, the arc comprises a portion which is substantially stirrup or “U” shaped when seen from above and comprises a central bar between the branches of the “U” which forms a domed portion, which can for example come into abutment against the hard palate of the patient, to ensure a good strength of the assembly.

Supported by the arc A there are the plate 14 and its sensors.

The latter comprises a so-called measurement end proper, provided with a central part C without sensors and two peripheral parts H, symmetrical relative to the transverse axis XX′ of the sensor member 6, within the arc and facing the teeth, provided with said sensors 17.

The plate also comprises connection pins 33, outside the support arch on the side opposite the central part C and toward the handle to be held by the dentist.

These electric connection pins 33 come into contact with pins (not represented) secured to a support plate R (chain-dotted line) which make it possible to recover the measurements from the plate and transmit them to the computation means via the acquisition board 9.

In one embodiment of the invention, the plate 14 of sensors can be reused a determined number of times or is disposable.

Also shown in FIG. 4 is an enlargement of the sensor part proper which will now be described further.

In the embodiment more particularly described here, each row electrode 20 is duplicated by an offset parallel electrode 20′ allowing for geometrical flexibility in the formation of the detecting member; in particular, that allows the “U” shaped formation of the plate.

The two electrodes 20, 20′ thus form a pair of electrodes.

Each row electrode (one per pair) and column electrode is connected to a connection pin 33 that is known per se and mounted on the support piece and forms a connection element.

For a given row or column, there is a single electrical connection pin 33.

The electrical principle of the measurement will now be described.

An electrical voltage is for example applied between a row pin 20 and a column pin 30.

The intensity of the current is measured at one of the pins and is, according to Ohm's law, a function of the electrical resistance over the path of the electrons.

When a pressure is exerted on a pressure sensor, the geometry of the piezoelectric layer is modified and therefore its electrical properties including its resistivity.

The electrical measurement can be linked to a geometrical datum because the electrical contact can be made between row and column only through the piezoelectric layer and via the holes passing through the insulating layer.

The electrical resistance value of such a material is modified in a physical deformation according to the equation:

ε*FG=ΔR/R0

where ΔR is the variation of electrical resistance between the initial resistance and the final resistance, R0 is the initial electrical resistance, FG is the gauge factor (constant characteristic of the piezoelectric material) and ε (epsilon) is the deformation of the material, which makes it possible to establish the link with an external pressure.

More specifically, considering the predominant characters of the Young's moduli of the PEN and of the silicon nitride (respectively 270 GPa and 6.45 GPa) relative to the other layers, the model previously described can relate to a layer of PEN sandwiched between two layers of silicon nitride. The layers having, for example and respectively, thicknesses of 125 μm, 550 nm and 250 nm.

Thus, a model is obtained that links the deformation and the measured resistance according to:

$$ɛ = ( \frac{1}{R} \pm \frac{1}{{R}_{0}} ) \frac{{d}_{s} + {d}_{f 1} + {d}_{f 2}}{2} \frac{χ ( {η}_{1}^{2} + {η}_{2}^{2} ) + 2 ( {χη}_{1} + {χη}_{1} {η}_{2} + {η}_{2} ) + 1}{{χ ( {η}_{1} + {η}_{2} )}^{2} + ( {η}_{1} + {η}_{2} ) ( 1 + χ ) + 1}$$

with ε: the deformation of the material
dₛ; d_{f1} and d_{f2}: the respective thicknesses of the PEN and of the layers of silicon nitride

$$χ = \frac{{Y}_{f}}{{Y}_{s}} ;$$

$${η}_{1} = \frac{{d}_{f 1}}{{d}_{s}} ;$$

$${η}_{2} = \frac{{d}_{f 2}}{{d}_{s}}$$

in which Yₛ and Y_{f} are the Young's moduli of the substrate (Yₛ), i.e. 2.5 GPa, and of the layers of silicon nitride (Y_{f}) i.e. 270 GPa.

By choosing this limitation, the computations of association of a pressure with a measured difference in resistance are simplified as shown by the linear nature of the experimental recording of the variation of current as a function of the deformation that always exhibits the same slope (FIG. 4A).

The abscissa shows the strain (epsilon) as a % and the ordinate shows the relative variation of the current. The four values obtained are given by varying the width (W) for the same length (L) or vice versa. This limitation makes it possible to obtain a measurement accuracy of the order of a micrometer.

In the embodiment more particularly described here, the device comprises acquisition means 5 (FIG. 5). These acquisition means comprise an acquisition board 34 on which are mounted a module 35 for multiplexing/demultiplexing the information from the rows 36 and the columns 37.

The board also comprises means 38 for adapting the electrical signal for it to be supplied to an analog/digital convertor 39/40 to allow processing by the computation means 10, and a module 41 for the board to communicate with the computer 12.

Each pressure measurement comprises two resistivity measurements, the first, called initial, without pressure to be measured applied and the second with the pressure to be measured applied to the object.

By way of example, the measurement of each sensor 17 can be performed according to the following scheme:
by random interrogation (invoked by application of a voltage to the corresponding pins) of any sensor present and so on until all have been interrogated.
by interrogation of all the sensors for a fixed column or row, until all the columns or rows have been interrogated.
by interrogation of a particular zone of interest.

A method according to an embodiment of the invention will now be described with reference to FIGS. 1, 6 and 7.

The dentist (hand 7) triggers the start of the measurement via the computer 12.

In a first step (42), a first run of the measurements of all of the sensors is carried out and the result is introduced into a memory of the computer in the form for example of “row 5-column 27-initial-28 (MΩ) megohms”.

In a second step (43), the support piece provided with the plate 14 is introduced into the mouth of the patient 5 who closes his jaw 4.

The plate 14 is therefore sandwiched between the upper and lower teeth.

The jaw then exerts and maintains a substantially constant pressure, for which the average pressure can easily be determined by averaged measurement and computation.

The computation means 10 then command (tap 44) a second measurement of all or some of the pressure sensors.

The results of the measurements are also introduced into the memory of the computer in the form, for example, of “row 5-column 27-measurement 1-245 Ω ohms”.

With the computation means 10 having the internal characteristics of the detecting member (notably the thicknesses and the Young's moduli of the materials) previously introduced into the computer and having the differences in resistance between the initial positions and positions under pressure for a given pair of coordinates (row/column), they determine therefrom the pressure applied to the plate for each pair of coordinates (step 45).

For each coordinate of the space in the plane, the computation means then associate (step 46) a resistance and therefore pressure difference value and establish the field of pressure intensities, thus producing the mapping (step 47) of the occlusion forces of the patient.

Each pressure intensity corresponds to an intensity of deformation and penetration of a tooth into the thickness of the detection plate.

The measurements thus make it possible to determine the surface (coordinates) and the occlusal forces (intensity of the pressure).

In one embodiment, the second measurement of the pressure can be reiterated (step 53), for example with a refresh rate greater than 100 hz so as to have a dynamic determination.

Also in an embodiment, the computation means' comprise date-stamping means and record, for each measurement, the time spent in relation to a reference event (for example the triggering of the measurement).

Thus, the dynamic measurement of the occlusion is performed.

Referring to FIG. 7, the computation means 10 also comprise means arranged to display dynamically on a computer screen 50 the mapping 11 of the occlusal forces and, optionally, the form 51 of the dentition of the patient by incorporating complementary data 52 (data on the jaw specific to a determined patient, history, dates, etc.).

These data are acquired by means that are known in themselves, of imaging, for example, optical and/or x-ray (not represented).

The data are then merged with the determined occlusal surface data to form a complete mapping 52 of the dentition 53 of the patient and of the occlusal forces 54 that he or she undergoes by eating.

This will allow the dentist in real time to modify the teeth and/or prostheses of the patient in a perfectly controlled and traceable manner in order to minimize and/or eliminate the stresses and the imbalance of the jaw.

A conventional menu 55, of windows (registered trademark) type makes it possible, for example, to move around within the different files without difficulty by simple clicks, summary representations for example in pie-chart form 56 being able to be displayed.

The acquired data are also refreshed dynamically.

As goes without saying and as results also from the above, the present invention is not limited to the embodiments more particularly described. On the contrary, it encompasses all the variants and notably those in which the layers of the intermediate layer are reversed in their order of stacking, or those in which the electrodes do not form pairs of electrodes but operate as a single electrode, or that in which a number of plates are used on a same support, or even those where the support plate 14 is fabricated by a different method.

1-9. (canceled)

10. System for determining the contact area and distribution of forces applied between the upper teeth and the lower teeth of the jaw of a patient, comprising:
a detection device configured to detect contact between teeth, and designed to be inserted between the teeth of the patient;
connection elements configured to connect the detection device with means for calculating the distribution of occlusal forces for mapping and said calculation means,
wherein said detection device comprises a support part for a removable flexible plate, said flexible plate being composed of a sheet made of a flexible plastic material fixed to a grid of pressure sensors including a first layer comprising a first network of row electrodes, a second intermediate layer with a variable resistivity depending on the pressure applied to it, and a third layer comprising a second network of column electrodes defining intersection zones with the row electrodes, wherein the grid of sensors comprises at least 5000 intersection zones adjacent to each other, with a square section smaller or equal to 600 micrometers; and
wherein the intermediate layer comprises a semi-conducting layer or slice of a piezoelectric material.

11. System according to claim 10, wherein the semiconducting slice is made of microcrystalline semiconducting silicon less than or equal to 50 nanometers thick.

12. System according to claim 11, wherein the intermediate layer is formed from a doped silicon plasma deposit on an insulating layer.

13. System according to claim 10, wherein the metal is aluminium.

14. System according to claim 10, wherein the first layer comprises more than a hundred row electrodes and the third layer comprises more than fifty column electrodes.

15. System according to claim 10, wherein the first layer is between 200 nm and 400 nm thick, the intermediate layer is between 100 nm and 200 nm thick, the slice being less than 30 nm thick, and the third layer is between 400 nm and 600 nm thick.

16. System according to claim 10, wherein the connection elements comprise an acquisition board and a connection pin with the support part.

17. System according to claim 10, wherein the calculation means comprise means for dynamically displaying the map of occlusal forces on a computer screen, including data for the jaw specific to a determined patient.

18. Method of determining the contact area and distribution of occlusal forces applied between the upper teeth and the lower teeth of a jaw of a patient, comprising:
inserting a detection device between the teeth of the patient for detecting contacts between teeth;
measuring pressures by said detection device, which is provided with a sheet made of a flexible plastic material glued to a grid of pressure sensors comprising at least 5000 sensors adjacent to each other, with a square section smaller or equal to 600 micrometers, said grid comprising an intermediate layer with variable resistivity depending on the pressure, said intermediate layer comprising a slice made of a piezoelectric semiconducting material; and
mapping the occlusal forces calculated from the distribution of the measured pressures.

19. Method according to claim 18, wherein the piezoelectric semiconducting material is monocrystalline silicon less than or equal to 50 nanometers thick.

20. Method according to claim 18, further comprising
dynamically displaying, on a computer screen, the map including complementary data.
